(19) United States
(12) Patent Application Publication
(10) Pub. No.: US 2021/0034784 A1
(43) Pub. Date: Feb. 4, 2021

(54) DETANGLING VIRTUAL WORLD AND REAL WORLD PORTIONS OF A SET OF ARTICLES

(71) Applicant: International Business Machines Corporation, Armonk, NY (US)

(72) Inventors: Aaron K. Baughman, Cary, NC (US); Garfield W. Vaughn, South Windsor, CT (US); Christian Eggenberger, Wil (CH); Gray Cannon, Miami, FL (US)

(21) Appl. No.: 16/528,793

(22) Filed: Aug. 1, 2019

(51) Int. Cl. G06F 21/64; G06N 3/08; G06F 16/951; G06F 16/9536; G06Q 50/00

(52) U.S. Cl. CPC G06F 21/64; G06N 3/08; G06Q 50/01; G06F 16/9536; G06F 16/951

(57) ABSTRACT

Using machine logic (for example machine learning, artificial intelligence, cognitive computing) to determine whether an article (that is text, sometimes accompanied by pictures, video and/or audio) relates to real world events that occurred in the real world, or virtual world events that occurred in a virtual world (for example, a fantasy sports league). Using machine logic (for example machine learning, artificial intelligence, cognitive computing) to determine whether various portions of an article relates to real world events, or virtual world events on a portion by portion basis.

### BACKGROUND

Computer systems often digests sets of pieces of texts to use as a corpus for responding to search queries, machine learning, cognitive computing, artificial intelligence, natural language parser training and the like. These pieces of text may take the form of books, multi-volume sets of books, magazine articles, newspaper articles, blog posts, internet media articles, podcasts, recorded lectures, movies, video log entries, plays and so on. The term “articles” shall be used herein to refer to any coherent and meaningful human understandable piece of text regardless of length or original format.

Some articles refer primarily to things that have, are or might happen in the real world. These types of articles, or portions of articles, are herein referred to as real world portions and/or real world articles. This term is roughly synonymous with the familiar term “non-fiction.” One example of a real world article would be a radio broadcast of a horse race as it occurred at a real world horse racetrack. Another example of a real world article would be set of patent statutes enacted by the government of some nation.

Some articles refer primarily to things that are made up, fiction, virtual world related and/or fantasy. These types of articles, or portions of articles, are herein referred to as virtual portions and/or virtual world articles. This term is roughly synonymous with the familiar term “fiction.” One example of a fiction article would be an article about the performance of players on a fantasy football team. Another example of a virtual article would be the poem The Hunting Of Snark by Lewis Carroll.

Fantasy sports, e-sports, augmented and virtual reality are expanding paradigms within user experience. For example, e-sports now includes a bona fide professional league where teams are associated with real world professional basketball teams. Drafts occur and video game players earn a salary to compete with each other. However, fantasy sports are virtual in that the players and teams do not play actual, real world games against each other—for example, the results of a fantasy game may be based upon statistics that the real world players achieved in real world games, but the fantasy game itself does not take place in the real world. Fantasy sports is a growing space with at least many millions of users. Augmented reality games or even trying on virtual garments at home are revolutionizing play and business. As users experience these environments, they tweet or write stories about their encounters in these virtual spaces. Professional beat writers and reporters cover many e-sports leagues and write about the video game action. Many artificial intelligence systems that provide projections, forecasts or other modeling techniques use the open Internet to process unstructured text (that is, various articles of a corpus).

As of 9 Jul. 2019, the Wikipedia entry on Word2vec states as follows: “Word2vec is a group of related models that are used to produce word embeddings. These models are shallow, two-layer neural networks that are trained to reconstruct linguistic contexts of words. Word2vec takes as its input a large corpus of text and produces a vector space, typically of several hundred dimensions, with each unique word in the corpus being assigned a corresponding vector in the space. Word vectors are positioned in the vector space such that words that share common contexts in the corpus are located in close proximity to one another in the space . . . . Embedding vectors created using the Word2vec algorithm have many advantages compared to earlier algorithms such as latent semantic analysis.” (footnote omitted)

### SUMMARY

According to an aspect of the present invention, there is a computer-implemented method, computer program product and/or system that performs the following operations (not necessarily in the following order): (i) receiving a first article data set including information relating to a first article; (ii) applying a plurality machine logic-based rules to the first article data set to determine that the first article is a real world article; and/or (iii) responsive to the determination that the first article is a real world article, taking a responsive action.

According to an aspect of the present invention, there is a computer-implemented method, computer program product and/or system that performs the following operations (not necessarily in the following order): (i) receiving a first article data set including information relating to a first article; (ii) applying a plurality machine logic-based rules to the first article data set to determine that the first article is a virtual world article; and/or (iii) responsive to the determination that the first article is a real world article, taking a responsive action.

According to an aspect of the present invention, there is a computer-implemented method, computer program product and/or system that performs the following operations (not necessarily in the following order): (i) receiving a first article data set including information relating to a first article; (ii) applying a plurality machine logic-based rules to the first article data set to determine that: (a) a first portion of the first article includes information relates to real world events, and (b) a second portion of the first article includes information relating to virtual world events; and/or (iii) responsive to the determination that the first portion of the first article relates to the real world and the second portion of the first article relates to the virtual world, taking a responsive action.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4A is a first screenshot view generated by the first embodiment system;

FIG. 4B is a second screenshot view generated by the first embodiment system;

FIG. 5 is a block diagram of a second embodiment of a system according to the present invention; and

FIG. 6 is a flowchart of a third embodiment of a method according to the present invention.

### DETAILED DESCRIPTION

Some embodiments of the present invention use machine logic (for example machine learning, artificial intelligence, cognitive computing) to determine whether an article (that is text, sometimes accompanied by pictures, video and/or audio) relates to real world events that occurred in the real world, or virtual world events that occurred in a virtual world (for example, a fantasy sports league). Some embodiments of the present invention use machine logic (for example machine learning, artificial intelligence, cognitive computing) to determine whether various portions of an article relates to real world events, or virtual world events on a portion by portion basis. This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

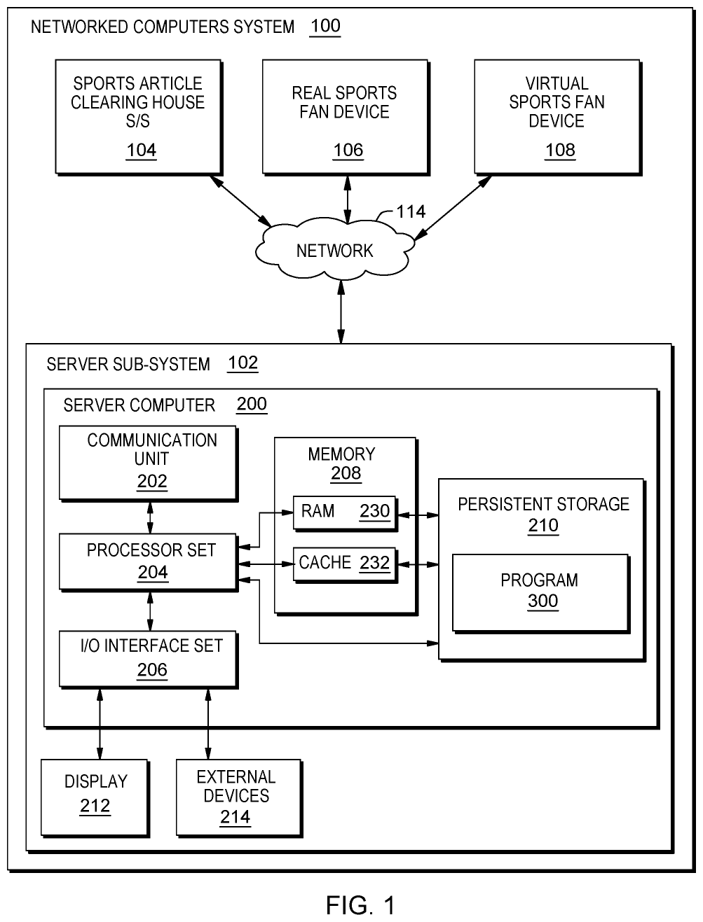

An embodiment of a possible hardware and software environment for software and/or methods according to the present invention will now be described in detail with reference to the Figures. FIG. 1 is a functional block diagram illustrating various portions of networked computers system 100, including: server sub-system 102; sports article clearinghouse sub-system 104; real sports fan device 106; virtual sports fan device 108; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

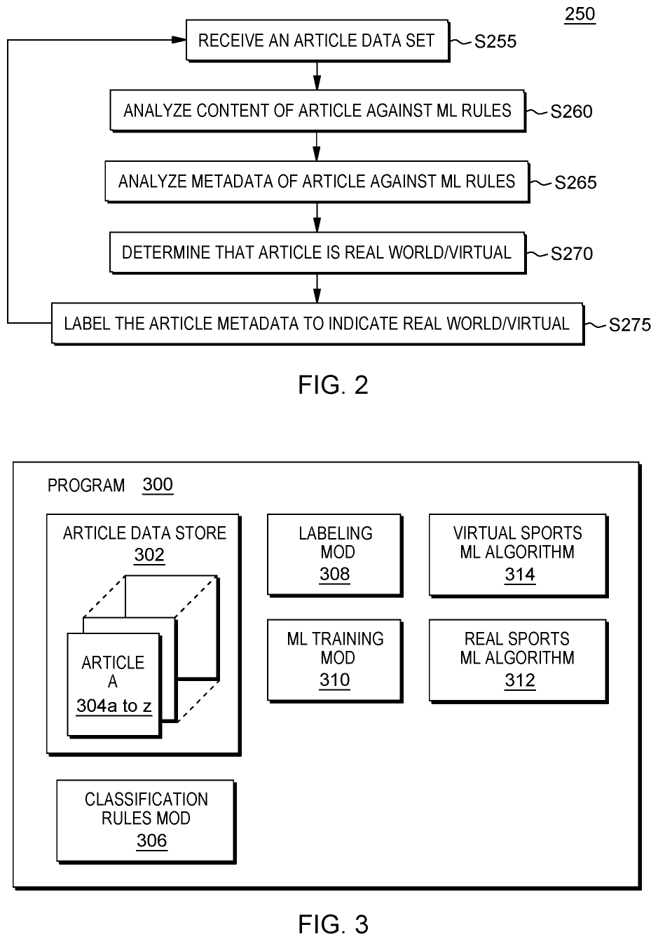

FIG. 2 shows flowchart 250 depicting a method according to the present invention.

FIG. 3 shows program 300 for performing at least some of the method operations of flowchart 250. This method and associated software will now be discussed, over the course of the following paragraphs, with extensive reference to FIG. 2 (for the method operation blocks) and FIG. 3 (for the software blocks).

Processing begins at operation S255, where a first article data set 304a (of the various article data sets 304a to 304z) is received by article data store 302, from sports clearinghouse sub-system 104 and over communication network 114 (see FIG. 1).

In this example, sports article clearinghouse subsystem 104 collects articles from various computer sources (for example, an online media outlet publishes an article about a fantasy league for fantasy play of the game of quoits) and non-computerized sources (for example, an optical scan of an article relating to a real life game of quoits match published in a popular general interest magazine in 1954). The articles always include text, and may often include other content, such as photographs, drawings, sound bites and/or video clips. Also, the articles typically include multiple types of metadata, such as: article publisher entity, article publication date, word count, reading level (difficulty), uniform resource locator (URL) address where article was published, publication format (for example, article published as a post on an internet message board), number of views that the article has and/or a tag indicating which sport the article relates to (for example, #gameofquoits). The computer readable data corresponding to an article's content and its metadata (if any) is collectively referred to as an article data set. An article data set may include multiple files, and may not even be in a file format at all.

In this example, sports article clearinghouse subsystem selects only articles that are related to one of the following: (i) real world play of the game of quoits; (ii) fantasy league play of the game of quoits; or (iii) both real world play of the game of quoits and fantasy league play of the game of quoits. As will become apparent during discussion, below, of subsequent operations of the method of flowchart 250, determining which of the three categories a given article belongs to is an objective of the method. In other words, sports article clearinghouse subsystem 104 filters the data that program 300 receives. Alternatively: (i) article data store 302 may collect the articles itself without a separate clearinghouse and its filtering; and/or (ii) article data store 302 may not filter the articles at all prior to applying the operations of the method of flowchart 250.

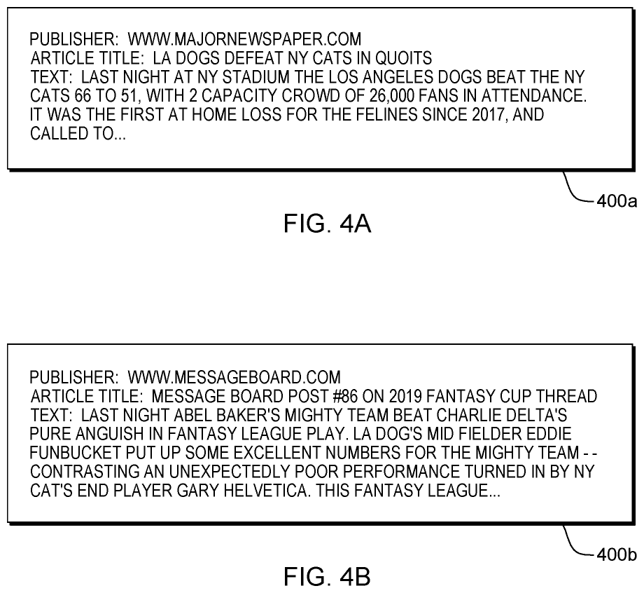

Processing proceeds to operation S260, where classification rules mod 306 analyzes the article content of first article data set 304a. Part of the content of the first article is shown in screen shot 400a of FIG. 4A. More specifically, in this example, at operation S260, the text of the first article is analyzed using a first machine logic based rule as follows:

### IF ARTICLE TEXT MENTIONS “ATTENDANCE” THEN THE ARTICLE IS A REAL WORLD ARTICLE CANDIDATE

As can be seen from screen shot 400a, the text of the article does mention the word attendance so the first article may very well be a real world article, relating to real world play of the game of quoits, as opposed to games of quoits played in games of quoits fantasy leagues. Accordingly, the first machine logic based rule denominates the second article as a real world candidate.

It should be kept in mind that this is a highly simplified example, with a limited number of machine logic based rules that are presented in a format designed to be easy for human readers to understand. Alternatively the machine logic based rules may be highly complex and relate to multiple dimensional vector space(s) and technologies like Word2Vec. These more complex embodiments will be discussed, below, in detail in the following sub-section of this Detailed Description section.

Processing proceeds to operation S265, where classification rules module (“mod”) 306 analyzes the article metadata of first article data set 304a. Part of the metadata, specifically, the publisher, of the first article is shown in screen shot 400a of FIG. 4A. More specifically, in this example, at operation S265, the publisher related metadata of the first article is analyzed using a second machine logic based rule as follows:

### IF A REAL WORLD ARTICLE CANDIDATE IS PUBLISHED BY A MAJOR NEWSPAPER THEN THE ARTICLE IS DEEMED TO BE A REAL WORLD ARTICLE

As can be seen from screen shot 400a, the first article (which has previously been denominated as a “real world candidate”) was published by a major newspaper, and is therefore deemed (at operation S270 and by mod 306) to be a “real world article,” as the term is defined, above, in the Background section. Alternatively, the articles may have no metadata, and, therefore, no machine logic rules relating to metadata. Also, it is not necessary, to apply metadata related rules after content related rules—that is only done in this example for pedagogical purposes to better communicate the underlying concepts. Also, a single machine logic based rule may implicate both content and metadata of an article at the same time.

Processing proceeds to operation S275 where, responsive to the determination at operation S270 that the first article data set 304A is a real world article, labelling mod 308 adds a tag to the first article data set to label the article as being a real world article about real world game play of the game of quoits. Alternatively, other kinds of responsive actions may be taken in response to the determination that an article is a real world article (or virtual world article), such as: (i) indexing for search engines; (ii) analyzing the text for research purposes (for example, filtering the focus to a correct search domain for applications built for academia, business, and/or government purposes); (iii) analyzing topic trends for the correct domain (for example, analyzing the popularity of a discussion of a real sports team on a social media platform while excluding the discussion of the virtual sports team analog of the real sports team on the social media platform); (iv) indexing and/or filtering results for specialized paid search engines; (v) providing references to news organizations; (vi) automatically posting results to a given social media platform for a correct domain; (vii) automatically moderating a given social media platform the correct domain; (viii) providing topical items for a blog or forum of discussion; (ix) automatically presenting headlines (on television and on the world wide web) in a ticker format; and/or (x) presenting relevant content to video game players while they are actively playing the video game.

Processing loops back to operation S255, where a second article data set 304b is processed, as will be discussed, below. However, before having that discussion, the use of the real world article labelling provided by the method of operation 250 will now be discussed. Machine learning (ML) training mod 310 trains real sports ML algorithm 312 based on the first article data set. More specifically, real sports ML algorithm 312 provides artificial intelligence (for example, insights, predictions, recommendations) related to the game of quoits as that game is played in the real world. It is known that the first article data set is suitable for helping to train this real world algorithm because the method of flowchart 250 has labelled this article as being a real world article. In this example, the artificial intelligence output of real sports ML algorithm 312 is delivered to real sports fan device 106 over network 114 (see FIG. 1).

Processing continues at operation S255, where a second article data set 304b (of the various article data sets 304a to 304z) is received by article data store 302, from sports clearinghouse sub-system 104 and over communication network 114 (see FIG. 1).

Processing proceeds to operation S260, where classification rules mod 306 analyzes the article content of second article data set 304b. Part of the content of the second article is shown in screen shot 400b of FIG. 4B. More specifically, in this example, at operation S260, the text of the second article is analyzed using a third machine logic based rule as follows:

### IF THERE IS MORE THAN ONE OCCURRENCE THE TEXT STRING “FANTASY” IN THE ARTICLE TEXT THEN THE ARTICLE IS A VIRTUAL WORLD ARTICLE CANDIDATE

As can be seen from screen shot 400b, the text of the article does mention the word fantasy more than one time so the second article may very well be a virtual world article, relating to virtual world play of the game of quoits, as opposed to games of quoits played in the real world game. Accordingly, the third machine logic based rule denominates the second article as a virtual world candidate.

Processing proceeds to operation S265, where classification rules module (“mod”) 306 analyzes the article metadata of second article data set 304b. Part of the metadata, specifically, the publisher, of the second article is shown in screen shot 400b of FIG. 4B. More specifically, in this example, at operation S265, the publisher related metadata of the second article is analyzed using a fourth machine logic based rule as follows:

### IF A VIRTUAL WORLD ARTICLE CANDIDATE IS PUBLISHED AS A POST ON A MESSAGE BOARD THEN THE ARTICLE IS DEEMED TO BE A VIRTUAL WORLD ARTICLE

As can be seen from screen shot 400b, the second article (which has previously been denominated as a “virtual world candidate”) was published by a message board, and is therefore deemed (at operation S270 and by mod 306) to be a “virtual world article,” as the term is defined, above, in the Background section.

Processing proceeds to operation S275 where, responsive to the determination at operation S270 that the second article data set 304b is a virtual world article, labelling mod 308 adds a tag to the second article data set to label the article as being a virtual world article about virtual world game play of the game of quoits. Alternatively, other kinds of responsive actions may be taken in response to the determination that an article is a virtual world article (or real world article), such as: (i) indexing for search engines; (ii) analyzing the text for research purposes (for example, filtering the focus to a correct search domain for applications built for academia, business, and/or government purposes); (iii) analyzing topic trends for the correct domain (for example, analyzing the popularity of a discussion of a real sports team on a social media platform while excluding the discussion of the virtual sports team analog of the real sports team on the social media platform); (iv) indexing and/or filtering results for specialized paid search engines; (v) providing references to news organizations; (vi) automatically posting results to a given social media platform for a correct domain; (vii) automatically moderating a given social media platform the correct domain; (viii) providing topical items for a blog or forum of discussion; (ix) automatically presenting headlines (on television and on the world wide web) in a ticker format; and/or (x) presenting relevant content to video game players while they are actively playing the video game.

Processing is now complete. However, separate and apart from the operations of the method of flowchart 250, the use of the virtual world article labelling provided by the method of operation 250 will now be discussed. Machine learning (ML) training mod 310 trains virtual sports ML algorithm 314 based on the second article data set. More specifically, virtual sports ML algorithm 314 provides artificial intelligence (for example, insights, predictions, recommendations, trends) related to the game of quoits as that game is played in the virtual world. It is known that the second article data set is suitable for helping to train this virtual world algorithm because the method of flowchart 250 has labelled this article as being a virtual world article. In this example, the artificial intelligence output of virtual sports ML algorithm 314 is delivered to virtual sports fan device 108 over network 114 (see FIG. 1).

### III. Further Comments and/or Embodiments

Some embodiments of the present invention may recognize one, or more, of the following problems, drawbacks, opportunities of improvement and/or challenges with respect to the currently convention state of the art: (i) the source of articles used by a computer system used to make projections, forecasts or the like may relate to an augmented reality (or other virtual space) while computer systems typically operate on the assumption that all articles relate to the real world; (ii) today, systems cannot determine the difference between the real world text (that is, real world articles or article portions) and augmented world text (that is, real world articles or article portions); (iii) e-sports, augmented reality and fantasy sports have their own set of news syndicates that produces stories about virtual events; (iv) the virtual based stories are mixed with real world stories within separate news articles; (v) further, real world and virtual world text can be entangled within the same article (that is, real world and virtual portions within a single article); and/or (vi) artificial intelligence (AI) systems that process the unstructured text have inaccurate projections or models due to the differences in text about the same subjects but within different contexts.

Some embodiments of the present invention may include one, or more, of the following features, characteristics, operations and/or advantages: (i) detangling the mining of virtual world and real world news articles; (ii) untangling real world and virtual news stories that are present within the same news article; (iii) untangling real world and virtual news stories that are present in separate articles; and/or (iv) overall, AI systems will be more accurate as the data sources become more precise in meaning.

Some embodiments of the present invention may include one, or more, of the following features, characteristics, operations and/or advantages: (i) production of virtual world embedding and virtual world embedding from a single text; (ii) produce independent summarized e-sports/virtual content for modeling; (iii) produce independent summarized real world content for modeling; (iv) merging of one (1) virtual content word 2 vector (“Word2vec”) and one (1) real world content Word2vec through RNN (recurrent neural networks) merge layers; (v) output of RNN to FNN (feedforward neural network) for determining a probability that a given portion (or article) of content is virtual content and determining a probability that a given portion (or article) is real world content; (vi) output of RNN to FNN (feedforward neural network) for a virtual world embedding and real world embedding; (vii) partial real world versus virtual probability statistics for a phrase and/or sentence in an article; (viii) detangling of virtual from real world and real world from virtual content; (ix) train highly accurate models for projections, classifications, etc. based probabilistically distinguishing real world portions (or articles) from virtual portions (or articles); (x) weight phrases with respect to real world contribution (that is, the probability that the phrase in question refers to real world events); and/or (x) weight phrases with respect to virtual world contribution (that is, the probability that the phrase in question refers to virtual world events).

Real World Case: Within a fantasy football project, the individuals involved are creating projections for scores, classifiers for boom/bust/player with injury/play meaningful minutes and evidence retrieval based on unstructured natural text. The text should be about a player in the real world and not about a player in virtual environments. The individuals involved have found that some text about virtual players and non-real world physics engines are hurting the accuracy of the models. A system according to an embodiment of the present invention is used to enhance our modeling efforts based on training and apply data for millions of users around the world.

Some embodiments of the present invention may include one, or more, of the following features, characteristics, operations and/or advantages: (i) a system and method that creates three Word2vec models with corresponding term frequency counts; (ii) the real world Word2vec uses a deep learning one hot encoding method to learn a text auto encoder; (iii) the text is projected into a large feature vector space; (iv) at the same time, we create another one hot encoding method for virtual language to learn an auto encoder; (v) the two Word2vec models now represent orthogonal representations of real and virtual sourced articles; (vi) a third model is produced for interlaced virtual and real world content; (vii) the real world and virtual world content auto encoders have residual layers that push weights into merge layers; (viii) as a result, the real world and virtual features vectors from every other layer of each is pushed into a merged recurrent model; (ix) the weights of the layers below the merged layers enter into a feed forward layer with the output classifying the average feature vector of a sentence or phrase as real world or physical world provenance and a Word2vec encoding; (x) the Word2vec encoding can be used to get real world summaries and virtual world summaries with a confidence value for each based on the classification of the text; (xi) in real time, sentences or phrases are fed into both real world and virtual world auto encoders that are then sent through residual layers within a series of parallel merge layers to provide an unentangled feature representation of the text as well as a probability as if the text is about an e-sport or real word event; and/or (xii) in addition, a real world and virtual separate encoding will be output from a single phrase.

An aggregation step for an entire article can use Bayes algorithm to compute the probability of whether an article is real world or virtual. For example: p(article is real world I text)=(probability(text I article is real world)*p(article is real world))/probability(text). A language model for text in real world provides probability of text while the aggregation of stats from an article provides the probability of the text given a real world assertion. A prior belief that an article could be from the world is adjusted based on the user or sources. As a result, methods according to an embodiment of the present invention can now be used to determine and filter two auto encoders into a merged RNN that feeds into an FNN. The gross stats (statistics) about an entire article provides all of the calculations for Bayes algorithm.

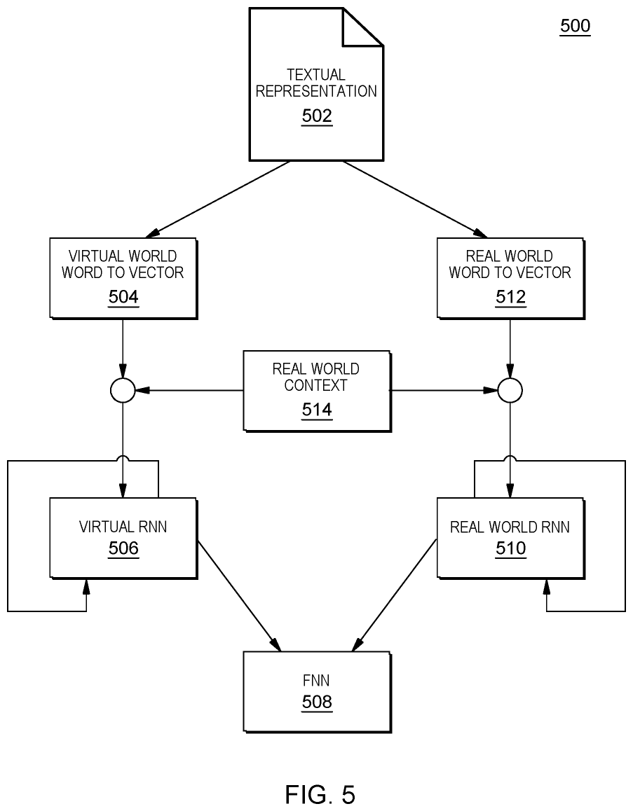

As shown in FIG. 5, block diagram 500 includes: textual representation block 502, virtual world word-to-vector block 504, virtual RNN block 506, FNN block 508, real world RNN block 510, real world word-to-vector block 512, and real world context block 514.

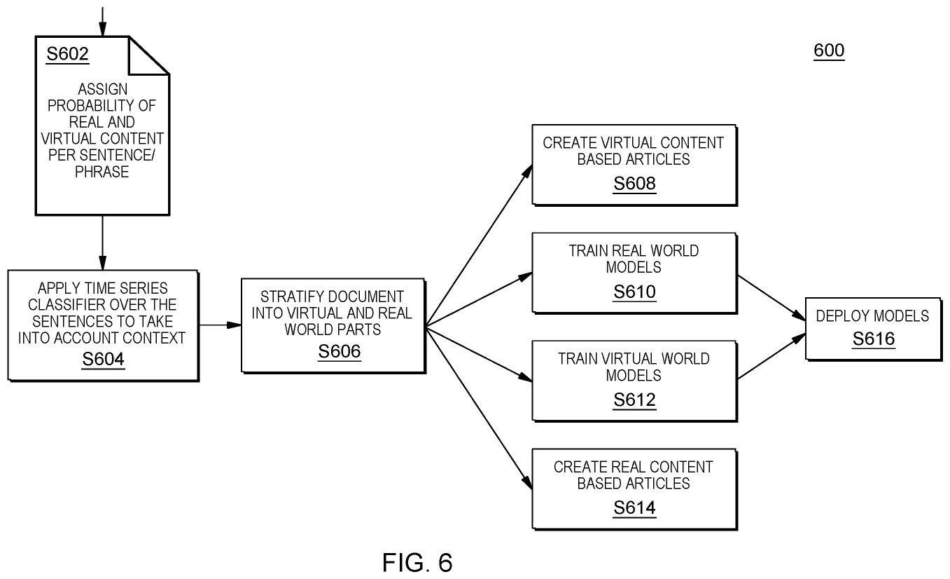

As shown in FIG. 6, flowchart 600 includes action steps that are taken by FNN block 508 (see FIG. 5). At step S602, the FNN block assigns a probability of real world and virtual world content for each given sentence and/or phrase in a given article. At step S604, the FNN block applies a time series classifier over the given sentences and/or phrases to take into account the context of those sentences and/or phrases. At step S606, the FNN block stratifies the given article (or “document”) into virtual parts and real world parts. At step S608, the FNN block creates virtual content-based articles (that is, articles based on events that occurred only in the virtual world and not in the real world). At step S610, the FNN block trains real world models. At step S612, the FNN block trains virtual world models. At step S614, the FNN block creates real content-based articles (that is, articles based on events that occurred only in the real world and not in the virtual world). At step S616, the FNN block deploys the created models (that is, the trained real world models from step S610 and the trained virtual models from step S612).

Some embodiments of the present invention may include one, or more, of the following features, characteristics, operations and/or advantages: (i) detangling of virtual from real world and real world from virtual content; (ii) production of virtual world embedding and virtual world embedding from a single text; (iii) produce independent summarized e-sports/virtual content for modeling; (iv) produce independent summarized real world content for modeling; (v) merging of one virtual content Word2vec and one real world content Word2vec through RNN merge layers; (vi) output of RNN to FNN for probability of virtual content and probability of real world content and a virtual world embedding and real world embedding; (vii) partial statistics for a phrase and/or sentence in an article; (viii) train highly accurate models for projections, classifications, etc. based on real world or virtual world; (ix) weight phrases with respect to real world contribution; and/or (x) weight phrases with respect to virtual world contribution.

Some embodiments of the present invention may include one, or more, of the following features, characteristics, operations and/or advantages: (i) detangling of virtual world information and real world information from mixed content that includes both of these types of information; (ii) production of virtual world embedding and real world embedding from a single text; (iii) single text can mean a phrase or sentence; (iv) so we can account for intertwined content from virtual/physical worlds; and/or (v) embedding is an auto-encoded feature vector from text.

Some embodiments of the present invention include detangling of virtual world information and real world information from mixed content that includes both of these types of information. In one example, a web article discusses the stellar performance of an eSports gamer playing a virtual football video game with a first football team. In the same article, the author mentions that the real-world football team (that is, the first football team that is playing in the real three-dimensional world) is having a poor season. Typically, Natural Language Processing (NLP) applications struggle with this apparent contradiction. For each analyzed text (that is, a sentence or a phrase) concerning the first football team, embodiments of the present invention calculates the probability that the analyzed text refers to the real-world football team. The text that is likely to be from the real world can be independently analyzed from the text that is likely to be from virtual world, and the system's comprehension is improved. For example, consider the following two sentences: (1) The first football team struggled mightily in 2017, failing to win a game; and (2) The first football team were simply unstoppable in the running game as VidGameStar employed a variety of juke moves. In this example, the first sentence refers to events that occurred in the real world, whereas the second sentence refers to events that occurred in the virtual world.

Some embodiments of the present invention include a production of virtual world embedding and real world embedding from a single text. In one example, a web article has a single sentence that discusses both a player's performance in the real world and his performance in the virtual world, such as: “BasketballPlayer had a season high points of 52 with BasketballTeam and a season high point total of 41 with the VideoGameTeam.” From that single sentence, embodiments of the present invention produces two embeddings, one for the real world and one for the virtual world. These two embeddings for the same text exist in different vector spaces so that when the text is decoded the generated content will be specific to the appropriate real world/virtual world context. For example, consider the following two sentences: (1) BasketballPlayer had a season high point total of 52; and (2) BasketballPlayer had a season high point total of 41. In this example, the first sentence is encoded into the real world word embedding, whereas the second sentence is encoded into the virtual world word embedding.

Embodiments of the present invention include producing independent summarized e-sports/virtual content for modeling. In one example, a web article describes a match of the VirtualBasketball eSports season between BasketballTeam1 and BasketballTeam2. These two teams also correspond to their real world Basketball team counterparts. This given web article is among many being analyzed, and the corpus will include articles that refer to both the real world team and the virtual world team. Embodiments of the present invention analyze this article using both a word-to-vector model that is trained specifically for the real world and one that is trained specifically for the virtual world. Each word-to-vector model results in a large feature vector that is reversed through the encoder (decoder) to produce words. These produced words are the words that are the most relevant for the vector. Similarly, as embodiments of the present invention produces encodings for sentences in the article, these most relevant words can be decoded through this encoder to generate sentences that summarize the article. By training specifically with virtual language, the auto encoder can generate summarized content that is relevant to the virtual world. A researcher can use the generated summary using the virtual world context because this system calculates a higher probability of virtual provenance for the article.

Embodiments of the present invention include producing independent summarized real world content for modeling. In one example, a web article describes a professional basketball game between BasketballTeam1 and BasketballTeam2. These franchises also have affiliated eSports teams that share these same team names. This given web article is among many being analyzed, and the corpus will include articles that refer to both the real world team and the virtual world team (that is, the eSports team). Embodiments of the present invention analyzes this given web article using both a word-to-vector model trained specifically for the real world and one trained specifically for the virtual world. Each word-to-vector model results in a large feature vector that is reversed through the encoder (decoder) to produce words. These produced are the words that are the most relevant for the vector. Similarly, as embodiments of the present invention produces encodings for sentences in the article, these most relevant words can be decoded through this encoder to generate sentences that summarize the article. By training specifically with real world language, the auto encoder can generate summarized content that is relevant to the real world. A researcher can use the generated summary using the real world context because this system calculates a higher probability of real world provenance for the article.

Some embodiments of the present invention include merging one virtual content word-to-vector and one real world content word-to-vector through RNN merge layers. In one example, a web article includes the sentence “The FootballTeam has been hard to beat at home.” Embodiments of the present invention analyzes this text using both a word-to-vector model trained on real world content and a second word-to-vector model trained on virtual world content. The real world and virtual world content auto encoders have residual layers that push weights into merge layers. As a result, the real world and virtual world feature vectors from every other layer of each (that is, the real world layers and virtual world layers) is pushed into a merged recurrent model. The weights of the layers below the merged layers then enter into a feed forward layer. The feed forward layer classifies the average feature vector of the phrase as real world or virtual world provenance and creates a word-to-vector encoding. The merging of real world content and virtual world content enables both the output of the real world auto encoder and the virtual world auto encoder to contribute to the calculation of provenance probabilities.

Embodiments of the present invention include output of RNN to FNN for probability of virtual content and probability of real world content and a virtual world embedding and real world embedding. In one example, a web article includes the following sentence: “It's been a great month for the BasketballTeam.” Embodiments of the present invention uses a Recurrent Neural Network (RNN) to analyze this piece of text because RNN can use sequencing for improved language comprehension. In embodiments of the present invention, the RNN used merges real world and virtual world features vectors. The weights of the layers below the merged layers are the output of the RNN. This output then enters a Feedforward Neural Network (FNN). This part of the system would not benefit from the cyclical nature of RNN. The job of the FNN then produces the following four outputs: (i) Probability the text is about the virtual world; (ii) Virtual world word embedding; (iii) Probability the text is about real world; and (iv) Real world word embedding.

Embodiments of the present invention produce partial statistics for a phrase and/or sentence in an article. In one example, a web article discusses GolfPlayer as both a real world golfer and as a golfer in a video game. The web article includes the sentence “No wonder GolfPlayer is surging up the GolfTournament rankings.” The web article also includes the sentence “Playing with GolfPlayer will give you an advantage.” Embodiments of the present invention use separate word-to-vector models for the real world and virtual world. This enables the system to calculate probabilities that each individual piece of text (that is, a particular sentence from the web article) pertains to either the real world or the virtual world. For example, consider the following two sentences: (1) No wonder GolfPlayer is surging up the GolfTournament rankings; and (2) Playing with GolfPlayer will give you an advantage. In this example, the probability that the first sentence relates to the real world is 85%, whereas the probability that the second sentence relates to the virtual world is 98%.

Embodiments of the present invention train highly accurate models for projections and classifications based on real world or virtual world. In one example, a researcher is trying to classify real world soccer teams according to playing styles. The classifications include the Spanish style (characterized by skillful dribbling and short passes) and the English style (characterized by strong physicality and long passes). The researcher is analyzing a large corpus of web articles about soccer matches. This corpus includes articles that discuss the real world soccer matches and video game (virtual world) soccer matches. Embodiments of the present invention calculates the probability that an article is discussing a real world soccer match, and the researcher can exclude articles that are likely to pertain to the virtual world soccer matches. By using only relevant articles to train the model, the classifier's accuracy, precision, and recall are improved. Similarly, if the researcher instead chose to analyze video game soccer teams, she would use the probabilities calculated by embodiments of the present invention to exclude real world articles and train the model solely on articles pertaining to the virtual world.

Embodiments of the present invention include determining weights to phrases with respect to real world contribution. It is important to understand the contribution that a given term (such as “stadium”) has on the classification of a piece of text (that is, a phrase or a sentence) as it pertains to the real world. Embodiments of the present invention calculate the frequency of this given term amongst a corpus of articles pertaining to the real world and the frequency amongst articles pertaining to the virtual world. The difference between the real world frequency and virtual frequency determines the contribution this term has to real world classification. With many more appearances in real world articles, the given term “stadium” has a large weight for real world contribution.

Embodiments of the present invention include determining weights to phrases with respect to virtual world contribution. It is important to understand the contribution that a given term (such as “player attribute”) has on the classification of a text (that is, a phrase or a sentence) as it pertains to the virtual world. Embodiments of the present invention calculate the frequency of this term amongst a corpus of articles pertaining to the virtual world and the frequency amongst articles pertaining to the real world. The difference between the virtual world frequency and real world frequency determines the contribution this term has to virtual world classification. With many more appearances in virtual world articles, the given term “player attribute” has a large weight for virtual world contribution.

Some embodiments of the present invention may include one, or more, of the following features, characteristics, operations and/or advantages: (i) using machine logic (that is, software) to take a piece of natural language text and determine from it: (a) a set of real world assertions applicable to the real world, and (b) a set of virtual world assertions applicable to virtual worlds; and/or (ii) using machine logic to take a set of real world assertions that are applicable to the real world, and a set of virtual world assertions that are applicable to virtual worlds, and to combine those into a single piece of natural language text.

Some embodiments of the present invention include a method of using artificial intelligence, machine learning and/or cognitive computing to determine whether a piece of text is fact (that is, non-fiction) or fiction. According to this method: (i) the fact relates to accounts of real life sports players and/or sports contests, and (ii) the fiction relates to fantasy sports activities.

Some embodiments of the present invention may include one, or more, of the following features, characteristics, operations and/or advantages: (i) builds auto encoders to project words into 500+ feature spaces that also represents semantic representation (that is, the spatial relationship of words that include word meaning, anaphora resolution, data normalization, entity resolution, nth degree word relationships, analogies, word rhythm, etc.) in addition to surface form (that is, sentence and/or paragraph grammar); (ii) combines the RNN in each independent domain (virtual world and real world); (iii) fuses with an FNN to provide a probability (on the phrase level) that a specific text is part of a class; (iii) uses a time series classification to take into account the contextual probability information; (iv) stratifies the content into different classes and trains virtual world and real world models from a given set of articles; (v) projects phrases within documents (that is, articles) into high dimensional space(s) that encodes virtual or real world aspects (that is, the projection of a word into hyperspace that shows the relative meaning and relationships of the word to other parts of text within the model); (vi) for example, if a word encoding model is created for football and the input word is “superbowl,” the output would be a large feature vector of numbers; and/or (vii) these numbers are used to find the closest words in the hyperspace to the numbers, which would provide an output of: “Patriots”, “Rams”, “Defense”, etc.

Some embodiments of the present invention may include one, or more, of the following features, characteristics, operations and/or advantages: (i) the hyperspace number is equal to the feature vector magnitude of the output of the auto encoder; (ii) each dimension represents how a neural network has learned to relate meaning to words; (iii) this meaning is determined by a series of activations that are trained during back propagation (for example, humans learn mathematically about words above and beyond human understanding); (iv) the length of the feature spaces needs to be more than fifty (50) so that it is sufficiently big enough to justify using the algorithm; (v) when there are fewer features, there are fewer dimensions in hyperspace which means that the mathematical equations learn less about the relationships of words; (vi) if a query was made based on the word encodings, you would get a word distance that says how closely seemingly unrelated words such as “knee” and “understanding” are to each other in hyperspace; (vii) this tells you given the text, how are the words related and that there will be a lineage of words based on context that link words together; and/or (viii) only works on sentence surface forms.

Some embodiments of the present invention may include one, or more, of the following features, characteristics, operations and/or advantages: (i) a method and system for detangling virtual world information and real-world information from mixed content or news stories; (ii) producing independent summarized virtual content and real-world content for modelling; (iii) determining whether a piece of text or content relates to real-world or virtual (fictional) based on artificial intelligence, cognitive computing or machine learning; (iv) detangling virtual content from the real-world, real world content from the virtual content and producing virtual world embedding from the real-world and vice versa; (v) analyzing an article using both a word-to-vector model and a Recurrent Neural Network (RNN); and/or (vi) generating a summarized content relevant to the virtual world and real-world by using an auto encoder; (vii) merging of both virtual content and real-world content with word-to-vector by using RNN merge layers; (viii) calculating weights of phrases with respect to real-world and virtual world contribution.

Some embodiments of the present invention may include one, or more, of the following features, characteristics, operations and/or advantages: (i) applies an algorithm that detangles words, phrases and sentences from content from the real world and the virtual world; (ii) the content is then summarized into two distinct categories for real world and virtual world modeling; (iii) uses partial statistics and multiple embedding for different types of text and produces summarized content for modeling; (iv) weights phrases based on partial content contribution; (v) correlates data to real world and virtual world events; (vi) detangles the content including co-references and anaphora resolution to produce new synthesized content; (vii) determines content from real world and virtual world where the data can have a correlation; (viii) creates new untangled resources (for phrases and sentences) that are used for separate training; (ix) generate new stories from the detangled information; and/or (x) disambiguates text where a real-world situation might refer to a virtual world situation or vice versa.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

What is claimed is:

1. A computer-implemented method (CIM) comprising:
receiving a first article data set including information relating to a first article;
applying a plurality machine logic-based rules to the first article data set to determine that the first article is a real world article; and
responsive to the determination that the first article is a real world article, taking a responsive action.

2. The CIM of claim 1 wherein the information relating to the first article of the first article data set includes at least one of the following types of information: text of the article, audio corresponding to the text of the article, video, still image(s) and/or metadata.

3. The CIM of claim 1 wherein the responsive action is one of the following types of responsive actions: applying a tag to the article data set specifying that the first article is a real world article, labeling the article data set to indicate that the first article is a real world article, using the article to train a machine learning computer system used to perform processing related to real world situations, indexing for search engines, analyzing the text for research purposes, analyzing topic trends for the correct domain, indexing results for specialized paid search engines, filtering results for specialized paid search engines, providing references to news organizations, automatically posting results to a given social media platform for a correct domain, automatically moderating a given social media platform the correct domain, providing topical items for a blog or forum of discussion, automatically presenting headlines in a ticker format, and/or presenting relevant content to video game players while they are actively playing the video game.

4. The CIM of claim 1 wherein the application of machine logic-based rules to the first article data set includes creating three Word2vec models with corresponding term frequency counts.

5. The CIM of claim 1 wherein the application of machine logic-based rules to the first article data set includes using Word2vec deep learning and one hot encoding to learn a text auto encoder.

6. The CIM of claim 1 wherein the application of machine logic-based rules to the first article data set includes projecting text of the first article into a large feature vector space.

7. The CIM of claim 1 further comprising:
receiving a second article data set including information relating to a second article;
applying a plurality machine logic-based rules to the second article data set to determine that the second article is a virtual world article; and
responsive to the determination that the second article is a virtual world article, taking a responsive action.

8. A computer-implemented method (CIM) comprising:
receiving a first article data set including information relating to a first article;
applying a plurality machine logic-based rules to the first article data set to determine that the first article is a virtual world article; and
responsive to the determination that the first article is a real world article, taking a responsive action.

9. The CIM of claim 8 wherein the information relating to the first article of the first article data set includes at least one of the following types of information: text of the article, audio corresponding to the text of the article, video, still image(s) and/or metadata.

10. The CIM of claim 8 wherein the responsive action is one of the following types of responsive actions: applying a tag to the article data set specifying that the first article is a real world article, labeling the article data set to indicate that the first article is a real world article, using the article to train a machine learning computer system used to perform processing related to real world situations, indexing for search engines, analyzing the text for research purposes, analyzing topic trends for the correct domain, indexing results for specialized paid search engines, filtering results for specialized paid search engines, providing references to news organizations, automatically posting results to a given social media platform for a correct domain, automatically moderating a given social media platform the correct domain, providing topical items for a blog or forum of discussion, automatically presenting headlines in a ticker format, and/or presenting relevant content to video game players while they are actively playing the video game.

11. The CIM of claim 8 wherein the application of machine logic-based rules to the first article data set includes creating three Word2vec models with corresponding term frequency counts.

12. The CIM of claim 8 wherein the application of machine logic-based rules to the first article data set includes using Word2vec deep learning and one hot encoding to learn a text auto encoder.

13. The CIM of claim 8 wherein the application of machine logic-based rules to the first article data set includes projecting text of the first article into a large feature vector space.

14. A computer-implemented method (CIM) comprising:
receiving a first article data set including information relating to a first article;
applying a plurality machine logic-based rules to the first article data set to determine that: (i) a first portion of the first article includes information relates to real world events, and (ii) a second portion of the first article includes information relating to virtual world events; and
responsive to the determination that the first portion of the first article relates to the real world and the second portion of the first article relates to the virtual world, taking a responsive action.

15. The CIM of claim 14 wherein the information relating to the first article of the first article data set includes at least one of the following types of information: text of the article, audio corresponding to the text of the article, video, still image(s) and/or metadata.

16. The CIM of claim 14 wherein the responsive action is one of the following types of responsive actions: applying a tag to the article data set specifying that the first article is a real world article, labeling the article data set to indicate that the first article is a real world article, using the article to train a machine learning computer system used to perform processing related to real world situations, indexing for search engines, analyzing the text for research purposes, analyzing topic trends for the correct domain, indexing results for specialized paid search engines, filtering results for specialized paid search engines, providing references to news organizations, automatically posting results to a given social media platform for a correct domain, automatically moderating a given social media platform the correct domain, providing topical items for a blog or forum of discussion, automatically presenting headlines in a ticker format, and/or presenting relevant content to video game players while they are actively playing the video game.

17. The CIM of claim 14 wherein the application of machine logic-based rules to the first article data set includes creating three Word2vec models with corresponding term frequency counts.

18. The CIM of claim 14 wherein the application of machine logic-based rules to the first article data set includes using Word2vec deep learning and one hot encoding to learn a text auto encoder.

19. The CIM of claim 14 wherein the application of machine logic-based rules to the first article data set includes projecting text of the first article into a large feature vector space.
